(19) United States
(12) Patent Application Publication
(10) Pub. No.: US 2016/0219061 A1
(43) Pub. Date: Jul. 28, 2016

(54) CONDITIONAL PROXIMITY BASED EQUIPMENT AUTHORIZATION KEY

(71) Applicants: Mark Adam Walton, Spring, TX (US); Eugene Thomas Johnson, Spring, TX (US)

(72) Inventors: Mark Adam Walton, Spring, TX (US); Eugene Thomas Johnson, Spring, TX (US)

(21) Appl. No.: 14/855,371

(22) Filed: Sep. 15, 2015

Related U.S. Application Data
(63) Continuation-in-part of application No. 14/657,198, filed on Mar. 13, 2015, now abandoned.
Application No. 14/657,198 is a continuation-in-part of application No. 14/657,231, filed on Mar. 13, 2015, now Pat. No. 9,305,407.
(60) Provisional application No. 62/109,029, filed on Jan. 28, 2015.

(51) Int. Cl. H04L 29/06

(52) U.S. Cl. CPC H04L 63/107; H04L 63/08

(57) ABSTRACT

An device for conditional, proximity based authorization for the use of equipment. The apparatus can comprise a key device capable of determining a position of the key device, identifying a user, and determining the status of one or more prerequisite conditions. The prerequisite conditions can also have subconditions, or be contingent upon other factors. The device can active enable or disable an apparatus for the user.

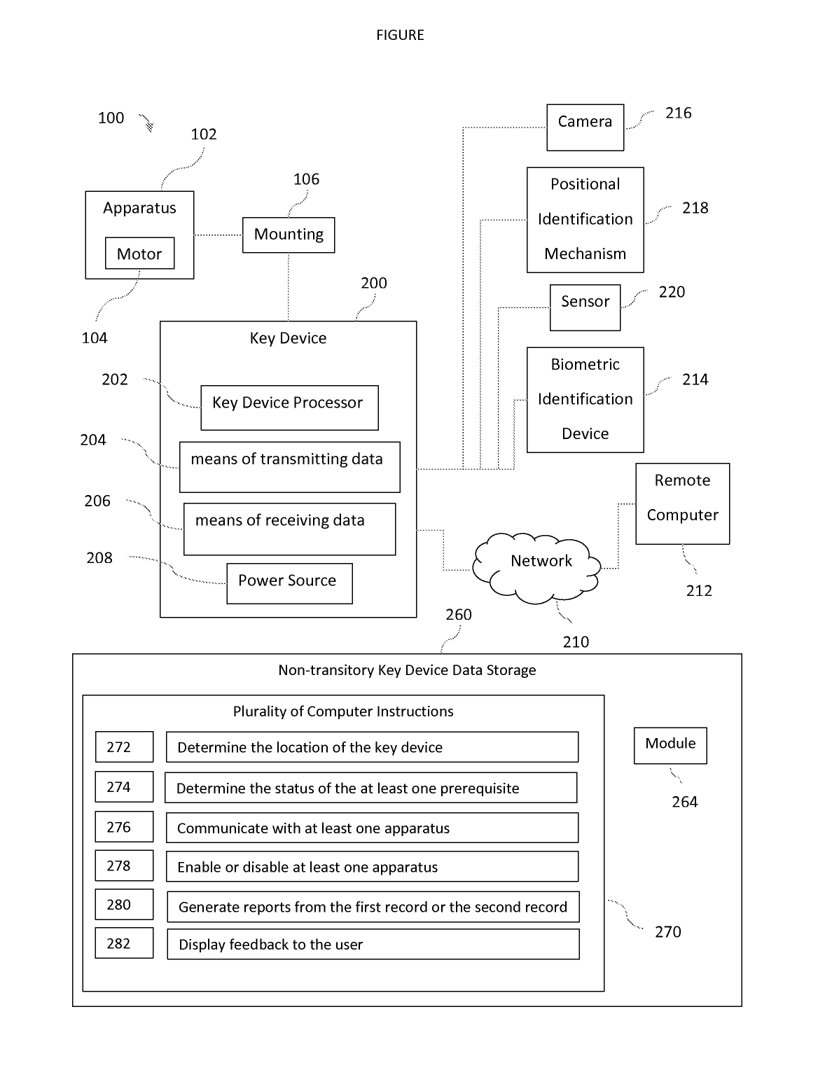

### CROSS REFERENCE TO RELATED APPLICATION

The current application is a Continuation in Part of co-pending application Ser. No. 14/657,198 filed Mar. 13, 2015, entitled “Fleet Management System”, and co-pending application Ser. No. 14/657,231 filed Mar. 13, 2015, entitled “Method for Fleet Management”, both of which claim priority to U.S. Provisional Patent Application Ser. No. 62/109,029 filed Jan. 28, 2015, entitled “Fleet Management System”. These references are incorporated herein in their entirety.

### FIELD

The present embodiments generally relate to an apparatus for conditional, proximity based authorization for the use of equipment.

### BACKGROUND

Although various types and forms of keys exist to access equipment and machinery operable by a user, keys in the current state of the art are typically passive items that merely allow for the use of equipment and machinery based upon the presence of the key.

Advances in technology have made it possible to broaden the function and usage of keys to incorporate various safety and business objectives related to the equipment and machinery.

For example, a key used to operate a lathe could determine whether the user has been certified for that specific piece of equipment. A key used to start and operate a vehicle could determine whether the user has a valid license, or has fulfilled certain safety tasks.

In addition to the determining whether certain conditions have been fulfilled, a need exists for a key that can actively disable equipment and machinery when certain conditions have or have not been met.

Further, a need exists for tracking usage of equipment and machinery to determine whether safety and business objectives have been met, in addition to allowing for easy reporting of equipment and machinery use.

The present embodiments meet these needs.

### BRIEF DESCRIPTION OF THE DRAWING

The detailed description will be better understood in conjunction with the accompanying drawing as follows:

The Figure is a block diagram illustrating the components of the device for conditional, proximity based equipment use authorization.

The present embodiments are detailed below with reference to the Figure.

### DETAILED DESCRIPTION OF THE EMBODIMENTS

Before explaining the present device in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The present invention relates to a device for conditional, proximity based authorization for the use of equipment by a user.

Key device as used herein can refer to any device capable of communicating electronically with a piece of equipment or machinery. Exemplary devices include, but are not limited to: cellular phones, laptop computers, tablet computers, portable media devices, wearable devices, implanted devices, and the like.

An operable apparatus, equipment, or machinery as used herein can refer to any device operable by a user, wherein it is desirable to restrict access to the device for safety or business reasons. Exemplary devices include, but are not limited to: industrial equipment, vehicles, electronic equipment, entry doors, safes, airplanes, forklifts, cranes, robots, drones, and the like.

The present invention comprises a key device for communicating with at least one apparatus operable by a user, wherein the at least one apparatus must be enabled for use. The apparatus can range from personally carried devices, such as cellular phones, to large pieces of machinery, such as construction equipment or vehicles.

Key devices currently in use can verify identity, or determine that the key corresponds to an apparatus in order to provide access to the apparatus.

The present invention discloses a key device which comprises not only a verification means that the key corresponds to an apparatus as described above but, in various embodiments, further comprises a positional identification mechanism for identifying a location of the key device, at least one prerequisite condition which must be fulfilled in order for the key device to enable operation of the apparatus, and a means of communication with the apparatus.

The key device can comprise a positional identification mechanism which determines a location of the key device. The location of the key device can further conditionally control operation of an apparatus as discussed more in detail below. The position of the key device can be determined as an absolute position, such as by the use of a global positioning system (GPS).

Alternatively, the position of the key device can be determined as a relative position in relation to some significant structure. For example, a vehicle key can determined to be within the vehicle, or external to the vehicle. Various means of determining such positions are known to persons having ordinary skill in the art. Determinations can be made using technology such as near field communications, magnetic sensors, radio emitting sensors, or any similar means.

The key device can also contain one or more prerequisite conditions which must be fulfilled in order to enable operation of an apparatus. Such a prerequisite condition can be incorporated in the key device via hard coding into the key device components, or implemented by using software to allow for rapid and easy customization of the prerequisite condition.

Prerequisite conditions can be dynamic and implemented from a remote location and transmitted to the key device.

The key device can comprise a computer to enable the storage of the prerequisite conditions. The key device can comprise a key device processor, a non-transitory key device storage, a means of transmitting data, a means of receiving data, and a power source, all in electronic communication with each other. Persons having ordinary skill in the art will be well aware of various structures accomplishing the above purposes.

The key device can store the prerequisite conditions locally on the key device storage, or communicated to the key device via a network such as the internet, peer to peer networks, satellite communication, a line of sight network, and the like. In embodiments, a remote computer can determine and transmit conditions to multiple key devices. Conditions can be determined based upon rules, or input manually by, for example, supervisory personnel.

It is important to note that the prerequisite condition can be a positive or a negative condition. An exemplary positive condition can be that the key device is inside a vehicle. An exemplary negative condition can be that the user of an apparatus has not been consuming alcohol, or even that the key device is not in the vehicle.

Various exemplary conditions that a user may need to meet in order to operate an apparatus include, but are not limited to: the key device is in a predetermined location, the key device is not in a predetermined location, a user of an apparatus has not completed a pre-usage inspection, a user of an apparatus has not walked in a pre-defined pattern prior to operation of an apparatus, a specific software is in operation on the key device, the apparatus has fuel or power below a certain level, apparatus is unsafe to operate, the apparatus is in need of repair, apparatus has been identified as having a defect, user is not authorized to operate the apparatus, user has not completed appropriate training, and the like.

Other conditions may include business specific conditions, such as an inspection report or logbook not being signed, the apparatus not having been serviced or inspected, an apparatus not in the proper location, a malfunction of the apparatus or key device, improper user identification through biometrics or behavior, health or physical condition of the user, driving at specific times of day or night, authorization level of the user, safety precautions not in place, preventive maintenance being due, low grease or oil level, increased potential for theft, and the like.

The prerequisite conditions can themselves be conditional, and comprise one or more subconditions. The subconditions can alter the actual prerequisite condition based upon various factors, such as environmental considerations, safety considerations, geographical considerations, and other similar considerations.

The key device can be in communication with one or more sensors, which may provide data upon which the prerequisite conditions or the subconditions may be contingent. The sensors can be any sensors that provide pertinent information. For example, an accelerometer in communication with the key device can determine that an accident has occurred due to the sudden deceleration of an apparatus. This in turn may create a prerequisite condition that a certain step or series of steps must be undertaken before the apparatus is enabled for operation.

In another example, a health monitoring device may be placed upon the user that does not allow for an apparatus to be operated by a user in poor health, i.e. the user has not had enough sleep or has a heart condition.

Numerous sensors exist known to persons having ordinary skill in the art for selection which can then be logically combined or linked to prerequisite conditions or subconditions customizable for a variety of safety, cost, environmental, business, or other goals.

The key device can determine a status of the at least one prerequisite condition and, through communication with the apparatus, can enable operation of at least one function of the at least one apparatus by the user if the key device is in a desired location and the at least one prerequisite condition has been fulfilled.

Alternatively, the key device can determine a status of the at least one prerequisite condition and, through communication with the at least one apparatus, actively disable operation of at least one function of the at least one apparatus by the user if the key device is not in the desired location or the at least one prerequisite condition has not been fulfilled.

The following narratives provide exemplary uses of the key device.

In one embodiment of the invention, the key device can be used by consumers for personal use. An exemplary use would be for a parent to prevent children from texting while driving a vehicle to ensure a safer environment for the child.

In this embodiment, the key device can be a worn item such as a wristband or a watch, a carried item such as a cellular phone or a personal tablet computer, or various combinations thereof.

The key device can comprise one or more prerequisite conditions, customizable by the parent or other authorized individual. In this embodiment, the prerequisite conditions can include elements such as determining whether the key device is within the vehicle, whether the key device is within the driver's seat, whether the vehicle is in motion, and the like.

The prerequisite conditions can themselves be conditional upon subconditions. For example, the conditions may vary based upon the user of the key device, the apparatus being controlled, the age of a child, and the like.

The key device can be in electronic communication with any apparatus capable of sending or receiving text messages. A parent can configure the key device to actively disable text messaging capability if, for example, the key device is within a vehicle which is moving at a rate greater than 3 miles per hour. A parent can allow for voice activated commands only when the vehicle is in motion. However, if rain is detected, then all or selected voice activated commands can be actively disabled if the key device is within a vehicle.

Determination of the location of the key device can be accomplished by various sensors transmitting information to the key device, such as via magnetic or radio waves, near field communication chips, a cradle or mounting within which the key device must be placed, and the like.

Alternative embodiments may also have the key device not allow a vehicle to be placed into “drive” or “reverse” when the user is actively texting or speaking on a phone. The key device can monitor the status of the prerequisite conditions, and enable or disable functions on the at least one apparatus as desired.

In another embodiment, the key device can be configured for commercial use.

A typical example might be a business with a fleet of vehicles, or a number of employees operating commercial equipment.

The key device in this instance can be a personal mobile device such as a cellular phone or a tablet pc. In other embodiments, the key device can be a wearable device, such as an electronic bracelet, a watch, an identification card worn on a lanyard, and the like.

In embodiments, the key device may be required to be placed within a mounting or cradle in order to make the vehicle or commercial equipment operational. In other embodiments, the location of the key device can be ascertained with various known mechanisms, such as magnetic or radio waves, near field communication chips, GPS, wireless network triangulation, and the like.

The key device can identify the user of the apparatus (vehicle or commercial equipment). In various embodiments, the identification can be as simple as a pin code that is input by the user. For more sensitive apparatus, the identification of the user can be more precise, and make use of various sensors or software to implement biometric identification such as facial recognition, fingerprint, retinal scans, voice recognition, and the like. It is contemplated that behavioral analysis can be implemented to aid in or be the primary means of identifying a user.

The key device can then identify the apparatus. The apparatus may be a specific piece of machinery, such as a lathe, power tool, a bulldozer, a backhoe, etc. In embodiments, the apparatus can be a specific vehicle in a fleet of vehicles.

The key device can be configured to control various apparatus. For example, in the instance of a commercial truck driver, the key device can enable or disable placing the vehicle into gear, while simultaneously enabling or disabling a phone from sending and receiving text messages.

A number of established and variable prerequisite conditions can be incorporated into the key device. The conditions may be resident upon the key device, or received by the key device through a transmission or synchronization process.

Prerequisite conditions may be contingent upon subconditions, and alter the behavior of the key device based upon various factors. Exemplary conditions and sub conditions include:

The specific user of the key device. The key device may operate differently based upon the user of the key device. Factors specific to the user such as training, licensure, alertness, certifications, level of authorization, hours of continuous service, health, experience, tenure, level of security clearance, and the like can all affect whether the prerequisite condition is met, or even dictate what the prerequisite condition is.

The specific apparatus. As discussed above, a single key device can be used to enable or disable a number of apparatus. The specific piece of machinery, equipment, vehicle, aircraft, door, and the like can all affect whether the prerequisite condition is met, or dictate what the prerequisite condition is.

Environmental conditions. Elements such as geography, terrain, traffic, weather, time of day, level of radiation, chemical presence, electromagnetic pulse, contamination, and the like can all affect whether the prerequisite condition is met, or dictate what the prerequisite condition is.

Business considerations. Considerations such as the specific client for which work is performed, regulatory rules, local laws, insurance requirements, profit, and the like can all affect whether the prerequisite condition is met, or dictate what the prerequisite condition is.

Safety conditions. Considerations such as whether the apparatus has been properly inspected, whether insurance requirements are met, the current apparatus usage habits of the user, road hazards that have been reported or detected, the repair needs and history of the apparatus, wear and tear, presence of a recall notice, and the like can all affect whether the prerequisite condition is met, or dictate what the prerequisite condition is.

The above exemplary but non-limiting list of prerequisite conditions, in combination with a required proximity of the key device can be used to enable or disable certain functions of the apparatus.

For example, a commercial truck driver may not be allowed to put the vehicle into gear without completing a pre-trip inspection, if his license has expired, if the truck has a mechanical defect, etc. The operator of a bulldozer may not be allowed to start the vehicle if he is inputting data on his phone.

The key device can keep records of location, user inputs, and prerequisite conditions for reporting purposes at a later time.

Turning now to the Figure, the Figure is a block diagram illustrating the components of the device for conditional, proximity based equipment use authorization.

The device for conditional, proximity based equipment use authorization 100 can comprise an Apparatus 102, a mounting 106, and a key device, 200.

The apparatus 102, as discussed above, can be any apparatus that must be enabled for use by a user. Exemplary apparatus can range from personally carried devices, such as cellular phones, to large pieces of machinery, such as construction equipment or vehicles. In embodiments, the apparatus can comprise a motor 104.

In embodiments, the device 100 can comprise a mounting 106, wherein the mounting can constrain the motion of a key device 200. The mounting 106 can be a structure that selectively clasps the key such as a cradle for a phone or other similar structure. In embodiments, the mounting 106 can electronically communicate with the apparatus 102.

The device 100 can further comprise a key device 200. The key device can comprise a key device processor 202, a means of transmitting data 204, a means of receiving data 206, and a power source 208 all in electronic communication with each other.

The key device processor 202 can be any microprocessor used in computing devices or portable devices.

In embodiments the means of transmitting data 204 and the means of receiving data 206 can make use of any means known to persons having ordinary skill in the art for the transfer of data. Exemplary methods include, but are not limited to: physical channels such as wires, electromagnetic signals such as radio waves, line of sight signals, electrical signals, microwave signals, Bluetooth signals, WiFi signals, and the like.

The power source 208 can supply power to the key device 200 and its various components. In embodiments, the power source can be shared with or charged by the apparatus or a power source within the apparatus.

In embodiments, the key device 200 can be in communication with a remote computer 212 through a network 210. The remote computer can communicate with the key device through the means of transmitting data 204 and the means of receiving data 206.

The key device 200 can comprise a biometric identification device 214. Exemplary devices can include voice recognition devices, retinal scanners, fingerprint scanners, facial recognition cameras, and the like.

In embodiments, the key device 200 can be in communication with a camera 216. The key device can also be in communication with one or more sensors 220, such as an accelerometer, a heart rate monitor, a health monitoring device, an optical character recognition device, a computer such as a vehicle computer, gyrometer, global positioning sensor, odometer, speedometer, pedometer, breathalyzer, biometer, device to measure behavioral traits, and the like. Other sensors can include sensors for rain, temperature, tire pressure or tread wear, water level, or even data from interne databases (such as health care network data). Persons having ordinary skill in the art can determine sensors or data needed for specific applications.

The key device can comprise or be in electronic communication with a positional identification mechanism 218 to determine the position of the key device. The positional identification mechanism 218 can be a global positioning system, a fixed mounting whose location is known, or various magnetic, radio, near field communication mechanisms, and the like.

The key device can also comprise a non-transitory key device data storage 260. The data storage 260 can comprise a nonvolatile data storage medium for storage of information, computer instructions and the like.

In embodiments, the data storage 260 can comprise a prerequisite condition 262, a first record 266 of all user inputs, a second record 268 of the locations of the key device for a predetermined time, and a plurality of computer instructions 270.

The plurality of computer instructions 270 can include instruction 272 instructing the key device processor 202 to determine the location of the key device.

The plurality of computer instructions 270 can include instruction 274 instructing the key device processor 202 to determine the status of the at least one prerequisite condition.

The plurality of computer instructions 270 can include instruction 276 instructing the key device processor 202 to communicate with at least one apparatus 102.

The plurality of computer instructions 270 can include instruction 278 instructing the key device processor 202 to enable or disable at least one apparatus 102.

In embodiments, the data storage 260 can comprise a module 264 for identifying a user based upon behavioral patterns. Behavioral patterns can include physical traits such as stride length, manner of sitting, manner of standing, and the like. In embodiments, behavioral patterns can include learned behaviors or habits, such as a consistent order in which tasks are accomplished, a manner of completing a task, a manner of beginning a task, and the like.

In embodiments, the plurality of computer instructions 270 can include instruction 280 instructing the key device processor 202 to generate reports from the first record 266 of all user inputs, and/or the second record 268 of the locations of the key device.

Reports can comprise charts, graphs, and the like. A remote computer 212 can aggregate data for comparison to collected data, established standards and norms, or other benchmark data.

In embodiments, the plurality of computer instructions 270 can include instruction 282 instructing the key device processor 202 to display feedback to the user or send feedback to a remote computer 212.

While the present invention has been described with emphasis on the embodiments, it should be understood that within the scope of the appended claims, the embodiments might be practiced other than as specifically described herein by persons having ordinary skill in the art. Accordingly, the specification is intended to cover alternatives, modifications, and equivalents as may be included within the spirit and scope of the invention as defined in the following claims.

What is claimed is:

1. A device for conditional, proximity based equipment use authorization comprising:
a) a key device for communicating with at least one apparatus operable by a user, wherein the at least one apparatus must be enabled for use, and further wherein the key device comprises:
i) a positional identification mechanism for identifying a location of the key device;
ii) at least one prerequisite condition; and
iii) a means of communication with the at least one apparatus, wherein the positional identification mechanism determines the location of the key device, the key device determines a status of the at least one prerequisite condition, and
1) through communication with the at least one apparatus, enables operation of at least one function of the at least one apparatus by the user if the key device is in a desired location and the at least one prerequisite condition has been fulfilled; or
2) through communication with the at least one apparatus, disables operation of at least one function of the at least one apparatus by the user if the key device is not in the desired location or the at least one prerequisite condition has not been fulfilled.

2. The device of claim 1, wherein the at least one prerequisite condition comprises a subcondition.

3. The device of claim 1, wherein the at least one prerequisite condition comprises a plurality of subconditions.

4. The device of claim 1, wherein the at least one prerequisite condition is contingent upon the location of the key device.

5. The device of claim 1, wherein the at least one apparatus comprises a motor.

6. The device of claim 1, wherein the at least one apparatus comprises a mounting capable of constraining the motion of the key device.

7. The device of claim 1, wherein the key device further comprises:
a) a key device processor;
b) a non-transitory key device data storage in communication with the key device processor;
c) a means of transmitting data, wherein the means of transmitting data is in communication with the key device processor;
d) a means of receiving data, wherein the means of receiving data is in communication with the key device processor;
e) a power source in electronic communication with the key device processor, the non-transitory key device storage, the means of transmitting data, and the means of receiving data; and
f) a plurality of computer instructions.

8. The device of claim 7, wherein the at least one prerequisite condition is stored within the non-transitory key device storage or the at least one prerequisite condition is communicated to the key device via the means of receiving data.

9. The device of claim 7, wherein the key device is in communication with one or more sensors.

10. The device of claim 7, wherein the key device further comprises a first record comprising all inputs to the key device by the user.

11. The device of claim 7, wherein the key device further comprises a second record comprising the location of the key device.

12. The device of claim 7, wherein the plurality of computer instructions comprise computer instructions instructing the processor to:
a) determine the location of the key device;
b) determine the status of the at least one prerequisite condition;
c) communicate with the at least one apparatus; and
d) enable or disable the at least one apparatus.

13. The device of claim 7, wherein the key device further comprises a means of identifying the user.

14. The device of claim 9, wherein the one or more sensors are selected from the group consisting of:
a) an accelerometer;
b) a heart rate monitor;
c) a health monitoring device;
d) an optical character recognition device;
e) a computer;
f) a gyrometer;
g) a global positioning sensor;
h) an odometer;
i) a speedometer;
j) a pedometer;
k) a breathalyzer;
l) a biometer; and
m) a device to measure behavioral traits.

15. The device of claim 12, wherein the plurality of computer instructions further comprise computer instructions instructing the processor to display feedback to the user.

16. The device of claim 12, wherein the plurality of computer instructions further comprise computer instructions instructing the processor to generate a report from the first record or the second record.

17. The device of claim 12, wherein the plurality of computer instructions further comprise computer instructions instructing the processor to communicate with a remote computer.

18. The device of claim 13, wherein the means of identifying the user is biometric.

19. The device of claim 13, wherein the means of identifying the user is behavioral.
